(19) United States
(12) Patent Application Publication
(10) Pub. No.: US 2026/0253377 A1
(43) Pub. Date: Aug. 27, 2026

(54) IDENTITY IDENTIFICATION METHOD AND APPARATUS, DEVICE, MEDIUM, AND PROGRAM PRODUCT

(71) Applicant: Tencent Technology (Shenzhen) Company Limited, Shenzhen (CN)

(72) Inventors: Jun WANG, Shenzhen (CN); Jinkun HOU, Shenzhen (CN); Runzeng GUO, Shenzhen (CN); Shaoming WANG, Shenzhen (CN); Jingyun ZHANG, Shenzhen (CN)

(73) Assignee: Tencent Technology (Shenzhen) Company Limited, Shenzhen (CN)

(21) Appl. No.: 19/645,890

(22) Filed: Apr. 13, 2026

Related U.S. Application Data
(63) Continuation of application No. PCT/CN2025/093224, filed on May 7, 2025.

(30) Foreign Application Priority Data
Jul. 16, 2024 (CN) 202410959766.6

(51) Int. Cl. G06V 10/74; G06V 10/774; G06V 10/82; G06V 10/98; G06V 40/12; G06V 40/50

(52) U.S. Cl. CPC G06V 10/761; G06V 10/774; G06V 10/82; G06V 10/993; G06V 40/1365; G06V 40/50

(57) ABSTRACT

The present disclosure provides an identity identification method and apparatus, a device, a medium, and a program product, and may relate to Internet technologies. The method includes: obtaining a current biological feature of a first object; identifying identity information of the first object based on the current biological feature and respective first biological features of N objects, N being a positive integer; and identifying the identity information of the first object based on the current biological feature of the first object and respective second biological features of the N objects if the identification on the identity information of the first object based on the current biological feature of the first object and the respective first biological features of the N objects fails. In this way, object experience can be improved.

### RELATED APPLICATION

This application is a continuation of and claims the benefit of priority to PCT Application No. PCT/CN2025/093224, filed May 7, 2025, and entitled IDENTIFY RECOGNITION METHOD AND APPARATUS, DEVICE, MEDIUM, AND PROGRAM PRODUCT, which is based on and claims priority to Chinese Patent Application No. 202410959766.6, entitled “IDENTITY IDENTIFICATION METHOD AND APPARATUS, DEVICE, MEDIUM, AND PROGRAM PRODUCT” filed with the China National Intellectual Property Administration on Jul. 16, 2024. The above applications are incorporated herein by reference in their entireties.

### FIELD OF THE TECHNOLOGY

Embodiments of the present disclosure relate to the field of Internet technologies, and in particular, to an identity identification method and apparatus, a device, a medium, and a program product.

### BACKGROUND OF THE DISCLOSURE

With the continuous development of Internet technologies, object identity identification is applied to more service scenarios such as a payment scenario and a membership point scenario, to facilitate life of an object.

Currently, a server configured to implement identity identification may store one biological feature of each object, for example, a palm print feature, a face feature, or an iris feature. A terminal device may collect a current biological feature image of an object, and send the image to the server. The server performs feature extraction on the image, to obtain a current biological feature of the object. Further, the server may identify identity information of the object based on the current biological feature and biological features of N objects. The identity information identification manner may be referred to as a 1vN identity identification manner. If the identification on the identity information of the object succeeds in the 1vN identity identification manner, the server may perform payment, membership points, and the like based on the identity information of the object. If the identification on the identity information of the object fails in the 1vN identity identification manner, the server needs to guide the object to enter a mobile phone number on the foregoing terminal device, to determine a stored biological feature that is of the object and that corresponds to the mobile phone number, and identify the identity information of the object based on the current biological feature of the object and the stored biological feature of the object. The identity information identification manner may be referred to as a 1v1 identity identification manner. A requirement of the 1v1 identity identification manner is usually slightly lower than a requirement of the 1vN identity identification manner. An identity identification stage implemented in the 1v1 identity identification manner is also referred to as a 1v1 verification stage or a 1v1 mobile phone number verification stage.

However, in some complex scenarios, due to impact of an object posture, an environment factor, or the like, for example, in a palm print recognition scenario, features of some palm regions are not clear due to impact of an angle of a palm print, or features of some palm regions are not clear or even lost due to an environment change, for example, a stain situation occurs on the palm. Consequently, identification on the identity information of the object in the 1vN identity identification manner fails, and the 1v1 mobile phone number verification stage often needs to be performed. As a result, identity identification time is relatively long, and the object needs to perform user interface (UI) interaction, resulting in poor object experience.

### SUMMARY

Embodiments of the present disclosure provide an identity identification method and apparatus, a device, a medium, and a program product, to improve object experience.

According to a first aspect, an embodiment of the present disclosure provides an identity identification method, including: obtaining a current biological feature of a first object; identifying identity information of the first object based on the current biological feature and respective first biological features of N objects, N being a positive integer; and identifying the identity information of the first object based on the current biological feature and respective second biological features of the N objects if the identification on the identity information of the first object based on the current biological feature and the respective first biological features of the N objects fails.

According to a second aspect, an embodiment of the present disclosure provides an identity identification apparatus, including: an obtaining module and an identity identification module. The obtaining module is configured to obtain a current biological feature of a first object. The identity identification module is configured to: identify identity information of the first object based on the current biological feature and respective first biological features of N objects, N being a positive integer; and identify the identity information of the first object based on the current biological feature and respective second biological features of the N objects if the identification on the identity information of the first object based on the current biological feature and the respective first biological features of the N objects fails.

In some possible implementations, the identity identification module is specifically configured to identify the identity information of the first object based on the current biological feature and a second biological feature of each of the N objects.

In some possible implementations, the identity identification module is specifically configured to: detect a second object that is in the N objects and that is suspected to be the first object; and if there is the second object in the N objects and the second object has a second biological feature, identify the identity information of the first object based on the current biological feature and the second biological feature of the second object.

In some possible implementations, the identity identification module is specifically configured to: reduce a first similarity threshold used when the identity information of the first object is identified based on the current biological feature and the respective first biological features of the N objects, to obtain a second similarity threshold; calculate similarities between the current biological feature and the respective first biological features of the N objects; and determine an object that is in the N objects and whose similarity is greater than the second similarity threshold as the second object.

In some possible implementations, the identity identification module is specifically configured to: reduce a first score threshold used when the identity information of the first object is identified based on the current biological feature and the respective first biological features of the N objects, to obtain a second score threshold; calculate similarities between the current biological feature and the respective first biological features of the N objects, and determine a similarity score corresponding to each similarity; and determine an object that is in the N objects and whose similarity score is greater than the second score threshold as the second object.

In some possible implementations, the identity identification module is specifically configured to: if the second object has a plurality of second biological features, calculate a similarity between the current biological feature and each second biological feature of the second object; and identify the identity information of the first object based on the similarity between the current biological feature and each second biological feature of the second object.

In some possible implementations, the identity identification module is specifically configured to: if the second object has a plurality of second biological features, sequentially calculate similarities between the current biological feature and the plurality of second biological features of the second object in descending order of quality of biological feature collection images respectively corresponding to the plurality of second biological features; and if a similarity between the current biological feature and a target second biological feature of the second object is greater than a third similarity threshold, use identity information of the second object as the identity information of the first object, and stop calculating a similarity between the current biological feature and another second biological feature of the second object.

In some possible implementations, the identity identification module is further configured to: if there is no second object in the N objects, identify the identity information of the first object based on a terminal identifier of the first object.

In some possible implementations, the identity identification module is further configured to: if the second object does not have the second biological feature, identify the identity information of the first object based on a terminal identifier of the first object.

In some possible implementations, the identity identification module is specifically configured to: detect, based on the terminal identifier of the first object, a status of enabling a biological feature recognition-related function of the first object; and if the first object has not enabled the biological feature recognition-related function, identify the identity information of the first object based on the current biological feature and a first biological feature of the first object.

In some possible implementations, the apparatus further includes a storage model, configured to: if the identification on the identity information of the first object based on the current biological feature and the first biological feature of the first object succeeds, use the current biological feature as a second biological feature of the first object, and store the second biological feature of the first object.

In some possible implementations, the apparatus further includes a determining model, configured to: before the storage model uses the current biological feature as the second biological feature of the first object and stores the second biological feature of the first object, determine a quality score of a current biological feature collection image corresponding to the current biological feature. Correspondingly, the storage model is specifically configured to: if the quality score of the current biological feature collection image is greater than a preset score, use the current biological feature as the second biological feature of the first object, and store the second biological feature of the first object.

In some possible implementations, the determining model is specifically configured to: input the current biological feature collection image into a neural network model, to obtain the quality score of the current biological feature collection image.

In some possible implementations, the apparatus further includes a training model. The obtaining module is further configured to obtain a training sample of the neural network model. The training model is configured to train the neural network model by using the training sample of the neural network model.

In some possible implementations, the obtaining module is specifically configured to: obtain M biological feature images of a third object, M being an integer greater than 1; select a target biological feature image with highest quality in the M biological feature images; calculate similarities between the target biological feature image and other M−1 biological feature images than the target biological feature image in the M biological feature images; and form M−1 training samples of the neural network model by using the other M−1 biological feature images and a similarity between the target biological feature image and each of the other M−1 biological feature images.

In some possible implementations, the apparatus further includes a trigger model. If the first object does not enable the biological feature recognition-related function, the trigger model is configured to trigger of the first object to enable the biological feature recognition-related function.

In some possible implementations, if the first object does not enable the biological feature recognition-related function, the storage model is further configured to use the current biological feature as the first biological feature of the first object, and store the first biological feature of the first object.

In some possible implementations, the obtaining module is specifically configured to: obtain a current biological feature collection image of the first object; and perform feature extraction on the current biological feature collection image, to obtain the current biological feature of the first object.

According to a third aspect, an embodiment of the present disclosure provides an electronic device, including: a processor and a memory, the memory being configured to store a computer program, and the processor being configured to invoke the computer program stored in the memory and run the computer program, to perform the method according to any one of the first aspect or the implementations of the first aspect.

According to a fourth aspect, an embodiment of the present disclosure provides a computer-readable storage medium, configured to store a computer program, the computer program causing a computer to perform the method according to any one of the first aspect or the implementations of the first aspect.

According to a fifth aspect, an embodiment of the present disclosure provides a computer program product, including computer program instructions, and the computer program instructions causing a computer to perform the method according to any one of the first aspect or the implementations of the first aspect.

According to a sixth aspect, an embodiment of the present disclosure provides a computer program, the computer program causing a computer to perform the method according to any one of the first aspect or the implementations of the first aspect.

According to the technical solutions provided in the present disclosure, after identification on an identity of an object in a 1vN manner fails, a 1v1 mobile phone number verification stage is not directly entered, but a link in which identity identification verification is performed by using a second biological feature is added. The 1v1 mobile phone number verification stage is entered only when the verification fails in this link. When identification by using the second biological feature succeeds, the 1v1 mobile phone number verification stage does not need to be entered, so that identity identification time can be shortened, and the object may not need to perform UI interaction, to finally improve object experience.

### BRIEF DESCRIPTION OF THE DRAWINGS

To describe the technical solutions in embodiments of the present disclosure more clearly, the following briefly describes the accompanying drawings required for describing the embodiments. Apparently, the accompanying drawings in the following description show merely some embodiments of the present disclosure, and a person of ordinary skill in the art may still derive other drawings from these accompanying drawings without creative efforts.

FIG. 1 is an example schematic diagram of a system architecture according to an embodiment of the present disclosure.

FIG. 2 is an example flowchart of an identity identification method according to an embodiment of the present disclosure.

FIG. 3 is an example schematic diagram of a sixth neural network model according to an embodiment of the present disclosure.

FIG. 4 is an example schematic diagram of selecting a biological feature image according to an embodiment of the present disclosure.

FIG. 5 is an example schematic diagram of generating a training sample according to an embodiment of the present disclosure.

FIG. 6 is an example schematic diagram of preprocessing and model training according to an embodiment of the present disclosure.

FIG. 7 is an example flowchart of another identity identification method according to an embodiment of the present disclosure.

FIG. 8 is an example schematic diagram of an identity identification apparatus 800 according to an embodiment of the present disclosure.

FIG. 9 is an example schematic block diagram of an electronic device 900 according to an embodiment of the present disclosure.

### DESCRIPTION OF EMBODIMENTS

The following clearly and completely describes the technical solutions in embodiments of the present disclosure with reference to the accompanying drawings in the embodiments of the present disclosure. Apparently, the described embodiments are some of the embodiments of the present disclosure rather than all of the embodiments. All other embodiments obtained by a person of ordinary skill in the art based on the embodiments of the present disclosure shall fall within the protection scope of the present disclosure.

In the specification, claims, and the foregoing accompanying drawings of the present disclosure, the terms “first”, “second”, and so on are intended to distinguish between similar objects rather than indicating a specific order. Data used in this way is exchangeable in a proper case, so that the embodiments of the present invention described herein can be implemented in an order different from the order shown or described herein. Moreover, the terms “include”, “contain” and any other variants mean to cover the non-exclusive inclusion. For example, a process, method, system, product, or device that includes a list of steps or units is not necessarily limited to those steps or units, but may include other steps or units not expressly listed or inherent to such a process, method, product, or device.

In the embodiments of the present disclosure, the term “module” or “unit” refers to a computer program having a predetermined function or a part of the computer program, and works together with other relevant parts to achieve a predetermined objective, and may be all or partially implemented by using software, hardware (for example, a processing circuit or a memory), or a combination thereof. Similarly, one processor (or a plurality of processors or memories) may be configured to implement one or more modules or units. In addition, each module or unit may be a part of an overall module or unit including a function of the module or unit.

The embodiments of the present disclosure may relate to mobile payment, for example, palm swiping payment, in an Internet technology.

The Internet technology is an information technology developed and established based on a computer technology. In this way, individual computers or networks are associated together, to form a specific network system, and implement information transmission and sharing.

The mobile payment is electronic money payment performed by a mobile client by using an electronic product such as a mobile phone. The Internet, a terminal device, and a financial institution are effectively combined through the mobile payment, to form a new payment system. The mobile payment opens a new payment method, and makes electronic money begin to become popular.

The palm swiping payment technology is a payment method based on a biological recognition technology, and mainly uses a palm print recognition technology to implement payment. In the palm print recognition technology, a texture feature of a palm is scanned, to extract a unique palm print feature, and the palm print feature is compared with a prestored palm print feature, to verify an identity of an object and complete payment. The palm swiping payment technology has the advantages of high security and high accuracy. A palm print of each person is unique, and therefore is difficult to be copied or forged, which greatly improves security of payment. In addition, the palm print recognition technology also has very high recognition accuracy, and can accurately determine an identity of an object, to reduce risks of misjudgment and incorrect payment. In addition, the palm swiping payment technology is also convenient. An object does not need to carry any physical card or mobile phone, and only needs to place a palm on a palm swiping payment device to complete payment. This greatly simplifies a payment procedure, and improves payment efficiency.

In the palm swiping payment technology, a palm print+palm vein recognition technology may also be used, which can adapt to a complex light environment, and simplify operations of an object while improving payment efficiency.

In this embodiment of the present disclosure, mobile payment can be implemented after object identity identification is performed through a terminal device such as a palm swiping device and a payment backend server.

The embodiments of the present disclosure may not be limited to the mobile payment in the Internet technology, and may relate to, for example, technologies such as membership points and leasing a mobile power pack without a rent through palm swiping in the Internet technology.

Before the technical solutions of the embodiments of the present disclosure are described, related knowledge of the present disclosure is first described below.

1. Biological feature is a unique and measurable physical or behavior feature related to a living body. This feature may be configured for identifying or verifying an identity of an object. Common biological features may include a fingerprint feature, a palm print feature, an iris feature, a face feature, and the like.

2. 1vN identity identification manner is a manner of performing identity identification based on a currently obtained current biological feature and N stored biological features. Specifically, a similarity between the current biological feature and each of the N stored biological features may be calculated, a biological feature that is in the N stored biological features and whose corresponding similarity is greater than a similarity threshold is selected, and identity information that is of an object and that corresponds to the biological feature is used as identity information that is of the object and that corresponds to the current biological feature.

3. 1v1 identity identification manner is a manner of performing identity identification based on a currently obtained current biological feature and a stored biological feature. Specifically, a similarity between the current biological feature and the stored biological feature may be calculated, and if the similarity is greater than a similarity threshold, identity information that is of an object and that corresponds to the biological feature is used as identity information that is of the object and that corresponds to the current biological feature.

4. Palm swiping payment is a payment method in which payment authentication is performed by using a palm texture of a user.

5. Instant messaging client is a communication tool based on an Internet technology, and allows users to communicate with each other in real time in a manner such as text, voice, or video. Common instant messaging clients include WeChat, QQ, enterprise WeChat, and the like, but are not limited thereto. These communication tools usually provide functions such as instant messaging, a voice call, a video call, and file transmission, so that users can conveniently communicate and cooperate.

The following describes the technical problems to be resolved, the inventive idea, and the system architecture of the embodiments of the present disclosure.

As described above, in some complex scenarios, due to impact of an object posture, an environment factor, or the like, for example, in a palm print recognition scenario, features of some palm regions are not clear due to impact of an angle of a palm print, or features of some palm regions are not clear or even lost due to an environment change, for example, a stain situation occurs on the palm. Consequently, identification on identity information of the object in a 1vN identity identification manner fails, and a 1v1 mobile phone number verification stage often needs to be performed. As a result, identity identification time is relatively long, and the object needs to perform UI interaction, resulting in poor object experience.

In a related technology, for such a case in which identity identification failure is caused due to the object posture, the environment, and the like, a neural network model used in a 1vN identity identification stage is mainly trained by augmenting training data, to improve a generalization capability and robustness of the model. Specifically, more training data under the object posture and the environment needs to be obtained to train the neural network model, so that even if factors such as the object posture and the environment change, identity identification can also be performed on an object. However, in an actual case, the training data cannot cover all posture and environment changes, resulting in a possibility that the 1vN identity identification manner still fails. In addition, augmentation of the training data causes an increase in training costs.

To resolve the foregoing technical problems, in the present disclosure, a backend server may store a plurality of biological features of an object, for example, may store biological features of the object under different postures or different environments, so that after identification on an identity of the object in a 1vN manner fails, a 1v1 mobile phone number verification stage is not directly entered, but a link in which identity identification verification is performed by using a second biological feature is added. The 1v1 mobile phone number verification stage is entered only when the verification fails in this link. When identification by using the second biological feature succeeds, the 1v1 mobile phone number verification stage does not need to be entered, so that identity identification time can be shortened, and the object may not need to perform UI interaction, to finally improve object experience.

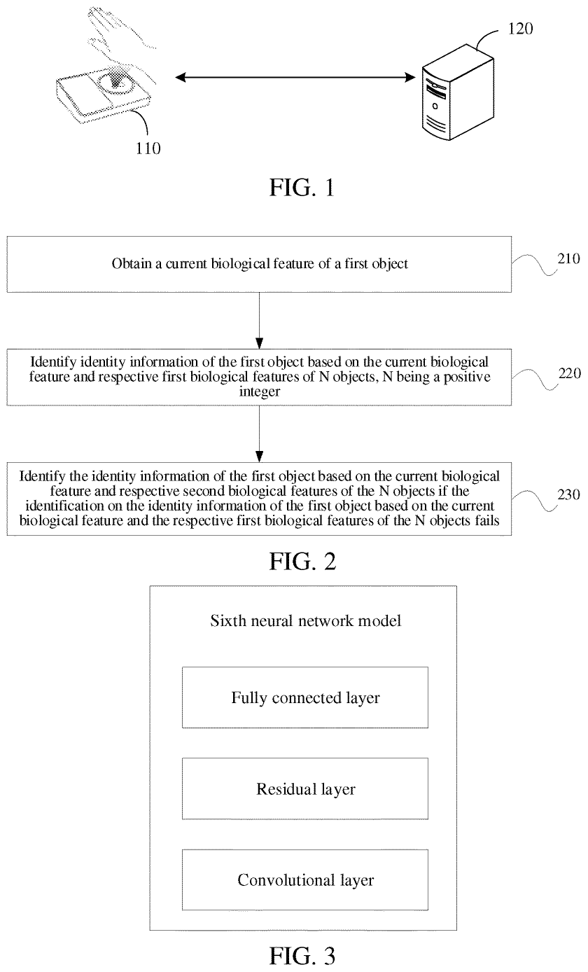

In some possible implementations, a system architecture of this embodiment of the present disclosure is shown in FIG. 1.

FIG. 1 is a schematic diagram of a system architecture according to an embodiment of the present disclosure. A terminal device 110 and a backend server 120 are included. The terminal device 110 and the backend server 120 may be directly or indirectly connected in a wired or wireless communication manner. This is not limited in the present disclosure.

An application (APP) configured to implement a biological feature recognition-related function may be installed on the terminal device 110. The biological feature recognition-related function may be a function such as payment, membership points, or leasing a mobile power pack without a rent performed based on identity information obtained through biological feature recognition, but is not limited thereto.

In some possible implementations, the application of the biological feature recognition-related function may be a payment application, a membership application, a mobile power pack leasing application, or the like, but is not limited thereto.

In some possible implementations, the payment application may be any application supporting a payment function. For example, the payment application may be an instant messaging client having the payment function.

In some possible implementations, a camera module is mounted on the terminal device 110 and is configured to collect a biological feature image, and the camera module may include an image collection device and a communication device. The image collection device may be, for example, a three-dimensional camera to which software and hardware related to image quality detection may be added, including a depth camera and an infrared camera. The communication device may be at least one of a wireless communication device (for example, Bluetooth) and a wired communication device.

In some possible implementations, the terminal device 110 may include but is not limited to: a mobile phone, a computer, an intelligent voice interaction device, a smart watch, virtual reality (VR), augmented reality (AR), a smart appliance, a vehicle-mounted terminal, an aircraft, a point of sale (POS) machine, a cash register, a self-help checking system, a code (payment code) scanning box, and the like.

In some possible implementations, the backend server 120 may be a backend server corresponding to the application configured to implement the biological feature recognition-related function, for example, a payment backend server. Alternatively, the backend server 120 may be a backend server corresponding to a mini program configured to implement the biological feature recognition-related function. For example, when the application of the biological feature recognition-related function is an instant messaging client, the backend server may be a backend server corresponding to a membership point mini program or a mobile power pack leasing mini program.

In some possible implementations, the backend server 120 may be an independent physical server, or may be a server cluster or a distributed system formed by a plurality of physical servers, or may be a cloud server that provides basic cloud computing services such as a cloud service, a cloud database, cloud computing, a cloud function, cloud storage, a network service, cloud communication, a middleware service, a domain name service, a security service, a content delivery network (CDN), big data, and an AI platform.

The backend server 120 may obtain a current biological feature of a first object; identify identity information of the first object based on the current biological feature and respective first biological features of N objects, N being a positive integer; and identify the identity information of the first object based on the current biological feature and respective second biological features of the N objects if the identification on the identity information of the first object based on the current biological feature and the respective first biological features of the N objects fails.

FIG. 1 shows one terminal device as an example. In some embodiments, the system architecture may include a plurality of terminal devices, and all the terminal devices are connected to the backend server 120. In conclusion, the system architecture to which the embodiments of the present disclosure are applied is not limited to the system architecture shown in FIG. 1.

Before the embodiments of the present disclosure are described, information involved in the embodiments of the present disclosure, including: a biological feature, object identity information, a biological feature image, and the like, is authorized by a relevant object or is fully authorized by all parties, and collection, use, and processing of the relevant information comply with relevant laws and regulations and standards of relevant countries and regions.

The following describes the embodiments of the present disclosure in detail.

FIG. 2 is a flowchart of an identity identification method according to an embodiment of the present disclosure. As shown in FIG. 2, the method may be performed by a backend server corresponding to an application configured to implement a biological feature recognition-related function. For example, the backend server may be a backend server corresponding to a payment backend server, a membership point mini program, or a mobile power pack leasing mini program, but is not limited thereto. As shown in FIG. 2, the method may include the following operations.

S210: Obtain a current biological feature of a first object.

Possible implementation 1: The backend server may obtain a current biological feature collection image of the first object; and perform feature extraction on the current biological feature collection image, to obtain the current biological feature of the first object.

In some possible implementations, a terminal device may collect the current biological feature collection image of the first object through a camera module, and send the current biological feature collection image to backend server. For example, a palm swiping device may collect the current biological feature collection image of the first object through a camera module on the palm swiping device, and send the current biological feature collection image to the backend server.

In some possible implementations, the backend server may input the current biological feature collection image into a first neural network model, to obtain the current biological feature of the first object.

In some possible implementations, before inputting the current biological feature collection image into the first neural network model, the backend server may preprocess the current biological feature collection image. Correspondingly, the backend server may input a preprocessed current biological feature collection image into the first neural network model, to obtain the current biological feature of the first object.

In some possible implementations, the preprocessing includes at least one of the following but is not limited: image denoising and image enhancement.

In some possible implementations, the first neural network model may be a convolutional neural network (CNN), a recurrent neural network (RNN), a long short-term memory network (LSTM), a gated recurrent unit (GRU), a bidirectional long short-term memory network (BiLSTM), a bidirectional gated recurrent unit (BiGRU), a transformer, a bidirectional encoder representation from transformers (BERT) model, but is not limited thereto.

Possible implementation 2: The terminal device may collect a current biological feature collection image of the first object through a camera module; and perform feature extraction on the current biological feature collection image, to obtain the current biological feature of the first object. The backend server receives the current biological feature of the first object sent by the terminal device.

A difference between the possible implementation 1 and the possible implementation 2 lies in that: in the possible implementation 2, the terminal device performs feature extraction on the current biological feature collection image, and in the possible implementation 1, the backend server performs feature extraction on the current biological feature collection image. Based on this, for a manner in which the terminal device performs feature extraction on the current biological feature collection image, reference may be made to a manner in which the backend server performs feature extraction on the current biological feature collection image. Details are not described again.

In some possible implementations, the current biological feature of the first object may be a fingerprint feature, a palm print feature, an iris feature, a face feature, or the like, but is not limited thereto.

S220: Identify identity information of the first object based on the current biological feature and respective first biological features of N objects, N being a positive integer.

The backend server has stored the respective first biological features of the N objects. For each of the N objects, a first biological feature of the object is a biological feature used in a 1vN identity identification link and a 1v1 mobile phone number verification link. In other words, the first biological feature is a stored biological feature of the object in a related art. Each object has one first biological feature. The first biological feature is also referred to as a main biological feature or a main feature.

For example, assuming that a biological feature in this embodiment of the present disclosure is a palm print feature, the backend server may store respective palm print features of the N objects, for subsequent use in the 1vN identity identification link and the 1v1 mobile phone number verification link.

For each of the N objects, the backend server may obtain a plurality of biological features of the object, but store only one biological feature with best quality of the object as a first biological feature of the object.

In some possible implementations, for each of the N objects, the backend server may input the current biological feature of the first object and the first biological feature of the object into a second neural network model, to obtain a similarity between the current biological feature of the first object and the first biological feature of the object, and identify the identity information of the first object based on the similarity and a first similarity threshold.

For each of the N objects, in addition to storing the first biological feature of the object, the backend server further stores identity information of the object. The identity information of the object has a correspondence with the first biological feature of the object.

In some possible implementations, for each of the N objects, if the similarity between the current biological feature of the first object and the first biological feature of the object is greater than the first similarity threshold, the backend server uses the identity information that is of the object and that corresponds to the first biological feature of the object as the identity information of the first object.

In some possible implementations, for each of the N objects, if the similarity between the current biological feature of the first object and the first biological feature of the object is greater than or equal to the first similarity threshold, the backend server uses the identity information that is of the object and that corresponds to the first biological feature of the object as the identity information of the first object.

In some possible implementations, the second neural network model may be a CNN, an RNN, an LSTM, a GRU, a BiLSTM, a BiGRU, a Transformer, or a BERT model, but is not limited thereto.

In some possible implementations, for each of the N objects, the backend server may input the current biological feature of the first object and the first biological feature of the object into a third neural network model, to obtain a similarity score between the current biological feature of the first object and the first biological feature of the object, and identify the identity information of the first object based on the similarity score and a score threshold.

In some possible implementations, for each of the N objects, the backend server may calculate a similarity between the current biological feature of the first object and the first biological feature of the object through the third neural network model, and determine the similarity score between the current biological feature of the first object and the first biological feature of the object based on the similarity.

In some possible implementations, a similarity interval [0, 1] may be divided into a plurality of sub-intervals, and each sub-interval corresponds to one similarity score. Based on this, the backend server determines, through the third neural network model, a similarity sub-interval corresponding to the similarity between the current biological feature of the first object and the first biological feature of the object, and determine a similarity score corresponding to the sub-interval as the similarity score between the current biological feature of the first object and the first biological feature of the object.

For example, the similarity interval [0, 1] is divided into 10 sub-intervals, which are respectively [0, 0.1], (0.1, 0.2], (0.2, 0.3], (0.3, 0.4], (0.4, 0.5], (0.5, 0.6], (0.6, 0.7], (0.7, 0.8], (0.8, 0.9], and (0.9, 1], and similarity scores respectively corresponding to the sub-intervals are respectively 1, 2, 3, 4, 5, 6, 7, 8, 9, and 10.

For each of the N objects, in addition to storing the first biological feature of the object, the backend server further stores identity information of the object. The identity information of the object has a correspondence with the first biological feature of the object.

In some possible implementations, for each of the N objects, if the similarity score between the current biological feature of the first object and the first biological feature of the object is greater than a first score threshold, the backend server uses the identity information that is of the object and that corresponds to the first biological feature of the object as the identity information of the first object.

In some possible implementations, for each of the N objects, if the similarity score between the current biological feature of the first object and the first biological feature of the object is greater than or equal to the first score threshold, the backend server uses the identity information that is of the object and that corresponds to the first biological feature of the object as the identity information of the first object.

In some possible implementations, the third neural network model may be a CNN, an RNN, an LSTM, a GRU, a BiLSTM, a BiGRU, a Transformer, or a BERT model, but is not limited thereto.

The identity information of the first object is configured for implementing a subsequent payment task, membership point task, task of leasing a mobile power pack without a rent, or the like.

In some possible implementations, the identity information of the first object includes at least one piece information of the following: basic information, a contact method, account information, and address information, but is not limited thereto.

In some possible implementations, the basic information of the first object includes at least one piece information of the following: a name, a gender, an age, and an identity card number that are of the first object, but is not limited thereto.

In some possible implementations, the contact method of the first object includes at least one piece information of the following: a telephone number and an email address that are of the first object, but is not limited thereto.

In some possible implementations, the account information of the first object includes at least one piece information of the following: a third-party payment account, bank card information, and an instant messaging client payment account, but is not limited thereto.

S220 is the 1vN identity identification link.

S230: Identify the identity information of the first object based on the current biological feature and respective second biological features of the N objects if the identification on the identity information of the first object based on the current biological feature and the respective first biological features of the N objects fails.

The backend server has stored the respective second biological features of the N objects. For each of the N objects, a second biological feature of the object is a biological feature used in an identity identification verification link mentioned in the embodiments of the present disclosure. In other words, the second biological feature is not a stored biological feature of the object in the related art. Each object has one or more second biological features. The second biological feature is also referred to as a secondary biological feature or a secondary feature.

In some possible implementations, for any object, a first biological feature and a second biological feature that are of the object may be biological features extracted based on biological feature images of the object collected under different postures or in different environments. It is assumed that the object includes a plurality of second biological features. These second biological features may also be biological features extracted based on biological feature images of the object collected under different postures or in different environments.

For example, assuming that a biological feature provided in this embodiment of the present disclosure is a palm print feature, a first biological feature and a plurality of second biological features that are of an object may be respectively palm print features corresponding to palm print feature images collected from different angles.

For example, assuming that a biological feature provided in this embodiment of the present disclosure is a palm print feature, a first biological feature and a plurality of second biological features that are of an object may be respectively palm print features corresponding to palm print feature images collected without shielding and when a local region is shielded.

For example, assuming that a biological feature provided in this embodiment of the present disclosure is a face feature, a first biological feature and a plurality of second biological features that are of an object may be respectively face features corresponding to face feature images collected from different angles.

For example, assuming that a biological feature provided in this embodiment of the present disclosure is a face feature, a first biological feature and one second biological feature that are of an object may be respectively face features corresponding to face feature images of the object collected when a mask is not worn and when the mask is worn.

In some possible implementations, the backend server may identify the identity information of the first object based on the current biological feature of the first object and a second biological feature of each of the N objects.

In some possible implementations, for each of the N objects, and for each second biological feature of the object, the backend server may input the current biological feature of the first object and a second biological feature of the object into a fourth neural network model, to obtain a similarity between the current biological feature of the first object and the second biological feature of the object, and identify the identity information of the first object based on the similarity and a third similarity threshold.

For each of the N objects, in addition to storing the second biological feature of the object, the backend server further stores identity information of the object. The identity information of the object has a correspondence with the second biological feature of the object.

In some possible implementations, for each of the N objects, if the similarity between the current biological feature of the first object and the second biological feature of the object is greater than the third similarity threshold, the backend server uses the identity information that is of the object and that corresponds to the second biological feature of the object as the identity information of the first object.

In some possible implementations, for each of the N objects, if the similarity between the current biological feature of the first object and the second biological feature of the object is greater than or equal to the third similarity threshold, the backend server uses the identity information that is of the object and that corresponds to the second biological feature of the object as the identity information of the first object.

In some possible implementations, the third similarity threshold may be less than or equal to the first similarity threshold, but is not limited thereto.

In some possible implementations, the fourth neural network model may be a CNN, an RNN, an LSTM, a GRU, a BiLSTM, a BiGRU, a Transformer, or a BERT model, but is not limited thereto.

In some possible implementations, for each of the N objects, the backend server may input the current biological feature of the first object and the second biological feature of the object into a fifth neural network model, to obtain a similarity score between the current biological feature of the first object and the second biological feature of the object, and identify the identity information of the first object based on the similarity score and a score threshold.

In some possible implementations, for each of the N objects, the backend server may calculate a similarity between the current biological feature of the first object and the second biological feature of the object through the fifth neural network model, and determine the similarity score between the current biological feature of the first object and the second biological feature of the object based on the similarity.

In some possible implementations, a similarity interval [0, 1] may be divided into a plurality of sub-intervals, and each sub-interval corresponds to one similarity score. Based on this, the backend server determines, through the fifth neural network model, a similarity sub-interval corresponding to the similarity between the current biological feature of the first object and the second biological feature of the object, and determine a similarity score corresponding to the sub-interval as the similarity score between the current biological feature of the first object and the second biological feature of the object.

For example, the similarity interval [0, 1] is divided into 10 sub-intervals, which are respectively [0, 0.1], (0.1, 0.2], (0.2, 0.3], (0.3, 0.4], (0.4, 0.5], (0.5, 0.6], (0.6, 0.7], (0.7, 0.8], (0.8, 0.9], and (0.9, 1], and similarity scores respectively corresponding to the sub-intervals are respectively 1, 2, 3, 4, 5, 6, 7, 8, 9, and 10.

In some possible implementations, for each of the N objects, if the similarity score between the current biological feature of the first object and the second biological feature of the object is greater than a third score threshold, the backend server uses the identity information that is of the object and that corresponds to the second biological feature of the object as the identity information of the first object.

In some possible implementations, for each of the N objects, if the similarity score between the current biological feature of the first object and the second biological feature of the object is greater than or equal to the third score threshold, the backend server uses the identity information that is of the object and that corresponds to the second biological feature of the object as the identity information of the first object.

In some possible implementations, the third score threshold may be less than or equal to the first score threshold, but is not limited thereto.

In some possible implementations, the fifth neural network model may be a CNN, an RNN, an LSTM, a GRU, a BiLSTM, a BiGRU, a Transformer, or a BERT model, but is not limited thereto.

In some possible implementations, the backend server may detect a second object that is in the N objects and that is suspected to be the first object. If there is the second object in the N objects and the second object has a second biological feature, the backend server identifies the identity information of the first object based on the current biological feature of the first object and the second biological feature of the second object.

In this implementation, the backend server does not need to identify the identity information of the first object based on the current biological feature of the first object and the second biological feature of each object, but identifies the identity information of the first object based on the current biological feature of the first object and the second biological feature of the second object, so that identity identification efficiency can be improved.

In some possible implementations, the backend server may reduce a first similarity threshold used when the identity information of the first object is identified based on the current biological feature of the first object and the respective first biological features of the N objects, to obtain a second similarity threshold; calculate similarities between the current biological feature of the first object and the respective first biological features of the N objects; and determine an object that is in the N objects and whose similarity is greater than the second similarity threshold as the second object.

The backend server may determine an adjustment range of the first similarity threshold according to an actual situation, to ensure as much as possible that the second object selected by using the second similarity threshold is the first object.

For example, it is assumed that the first similarity threshold is 0.9, and the second similarity threshold is 0.8, and it is assumed that the similarities between the current biological feature of the first object and the respective first biological features of the N objects are all less than 0.9. After the first similarity threshold is reduced, assuming that a similarity between the current biological feature of the first object and a first biological feature of an object 1 in the N objects is greater than 0.8, the object 1 may be determined as the first object.

In some possible implementations, the backend server may reduce a first score threshold used when the identity information of the first object is identified based on the current biological feature of the first object and the respective first biological features of the N objects, to obtain a second score threshold; and calculate similarities between the current biological feature of the first object and the respective first biological features of the N objects, determine similarity scores corresponding to the similarities, and determine an object that is in the N objects and whose similarity score is greater than the second score threshold as the second object.

The backend server may determine an adjustment range of the second score threshold according to an actual situation, to ensure as much as possible that the second object selected by using the second score threshold is the first object.

For example, it is assumed that the first score threshold is 9, and the second score threshold is 8, and it is assumed that the similarity scores between the current biological feature of the first object and the respective first biological features of the N objects are all less than 9. After the first score threshold is reduced, assuming that a similarity score between the current biological feature of the first object and a first biological feature of an object 1 in the N objects is greater than 8, the object 1 may be determined as the first object.

In some possible implementations, if the second object has one second biological feature, the backend server calculates a similarity between the current biological feature of the first object and the second biological feature of the second object; and identifies the identity information of the first object based on the similarity between the current biological feature of the first object and the second biological feature of the second object.

In some possible implementations, the identifying the identity information of the first object based on the similarity between the current biological feature of the first object and the second biological feature of the second object includes: If the similarity between the current biological feature of the first object and the second biological feature is greater than the third similarity threshold, the backend server determines identity information that is of the object and that corresponds to the second biological feature as the identity information of the first object.

In some possible implementations, the identifying the identity information of the first object based on the similarity between the current biological feature of the first object and the second biological feature of the second object includes: The backend server calculates a similarity score between the current biological feature of the first object and the second biological feature, and if the similarity score between the current biological feature of the first object and the second biological feature is greater than the third score threshold, the backend server uses identity information that is of the object and that corresponds to the second biological feature as the identity information of the first object.

If the second object has one second biological feature, a manner in which the backend server identifies the identity information of the first object based on the current biological feature of the first object and the second biological feature of the second object may be understood as a 1v1 identity identification manner based on the second biological feature. A requirement of the 1v1 identity identification manner is usually slightly lower than a requirement of the 1vN identity identification manner. Therefore, as described above, the third similarity threshold may be less than the first similarity threshold, and the third score threshold may be less than the first score threshold.

In some possible implementations, if the second object has a plurality of second biological features, the backend server calculates a similarity between the current biological feature of the first object and each second biological feature of the second object; and identifies the identity information of the first object based on the similarity between the current biological feature of the first object and each second biological feature of the second object.

In some possible implementations, the identifying the identity information of the first object based on the similarity between the current biological feature of the first object and each second biological feature of the second object includes: If the similarity between the current biological feature of the first object and any second biological feature of the second object is greater than the third similarity threshold, the backend server determines identity information that is of the object and that corresponds to the second biological feature as the identity information of the first object.

For example, it is assumed that the backend server stores two second biological features of an object 1, which are respectively: a palm print feature when a lower left palm is shielded and a palm print feature when a lower right palm is shielded. Both the biological features correspond to identity information of the object 1. Assuming that the backend server obtains a current palm print feature of the object 1, and a similarity between the current palm print feature and the palm print feature when the lower left palm is shielded is 90% and is greater than the third similarity threshold 80%, the backend server may determine the identity information of the object 1 based on a correspondence between the identity information of the object 1 and the palm print feature when the lower left palm is shielded.

For example, it is assumed that the backend server stores two second biological features of an object 1, which are respectively: a face feature when a mask is worn and a face feature when glasses are worn. Both the biological features correspond to identity information of the object 1. Assuming that the backend server obtains a current face feature of the object 1, and a similarity between the current face feature and the face feature when the mask is worn is 90% and is greater than the third similarity threshold 80%, the backend server may determine the identity information of the object 1 based on a correspondence between the identity information of the object 1 and the face feature when the mask is worn.

In some possible implementations, the identifying the identity information of the first object based on the similarity between the current biological feature of the first object and each second biological feature of the second object includes: If a similarity score between the current biological feature of the first object and any second biological feature of the second object is greater than the third score threshold, the backend server determines identity information that is of the object and that corresponds to the second biological feature as the identity information of the first object.

For example, it is assumed that the backend server stores two second biological features of an object 1, which are respectively: a palm print feature when a lower left palm is shielded and a palm print feature when a lower right palm is shielded. Both the biological features correspond to identity information of the object 1. Assuming that the backend server obtains a current palm print feature of the object 1, and a similarity score between the current palm print feature and the palm print feature when the lower left palm is shielded is 9 and is greater than the third score threshold 8, the backend server may determine the identity information of the object 1 based on a correspondence between the identity information of the object 1 and the palm print feature when the lower left palm is shielded.

For example, it is assumed that the backend server stores two second biological features of an object 1, which are respectively: a face feature when a mask is worn and a face feature when glasses are worn. Both the biological features correspond to identity information of the object 1. Assuming that the backend server obtains a current face feature of the object 1, and a similarity score between the current face feature and the face feature when the mask is worn is 9 and is greater than the third score threshold 8, the backend server may determine the identity information of the object 1 based on a correspondence between the identity information of the object 1 and the face feature when the mask is worn.

In some possible implementations, if the second object has a plurality of second biological features, the backend server sequentially calculates similarities between the current biological feature of the first object and the plurality of second biological features of the second object in descending order of quality of biological feature collection images respectively corresponding to the plurality of second biological features. If a similarity between the current biological feature of the first object and a target second biological feature of the second object is greater than a third similarity threshold, the backend server uses identity information of the second object as the identity information of the first object, and stops calculating a similarity between the current biological feature of the first object and another second biological feature of the second object.

In this implementation, the backend server may not need to calculate a similarity between each second biological feature of the second object and the current biological feature of the first object, but calculates similarities between the second biological features of the second object and the current biological feature of the first object in descending order of quality of biological feature collection images corresponding to the second biological features, and may stop calculating similarities provided that a similarity between the current biological feature of the first object and a second biological feature of the second object is greater than the third similarity threshold, so that identity identification efficiency can be improved.

In some possible implementations, the backend server may input any biological feature collection image into a neural network model, to obtain a quality score of the biological feature collection image. To distinguish the neural network model from the foregoing other neural network models, in the present disclosure, the neural network model herein may be referred to as a sixth neural network model.

In some possible implementations, the sixth neural network model may be a CNN, an RNN, an LSTM, a GRU, a BiLSTM, a BiGRU, a Transformer, or a BERT model, but is not limited thereto.

In some possible implementations, if the second object has a plurality of second biological features, the backend server sequentially calculates similarity scores between the current biological feature of the first object and the plurality of second biological features of the second object in descending order of quality of biological feature collection images respectively corresponding to the plurality of second biological features. If a similarity score between the current biological feature of the first object and a target second biological feature of the second object is greater than a third score threshold, the backend server uses identity information of the second object as the identity information of the first object, and stops calculating a similarity score between the current biological feature of the first object and another second biological feature of the second object.

In this implementation, the backend server may not need to calculate a similarity score between each second biological feature of the second object and the current biological feature of the first object, but calculates similarity scores between the second biological features of the second object and the current biological feature of the first object in descending order of quality of biological feature collection images corresponding to the second biological features, and may stop calculating similarity scores provided that a similarity score between the current biological feature of the first object and a second biological feature of the second object is greater than the third score threshold, so that identity identification efficiency can be improved.

In this embodiment of in the present disclosure, an identity identification condition in the 1vN identity identification link is relaxed, to identify an object that is suspected to be the first object, so that a second biological feature of the object may be determined, and the current biological feature of the first object is compared with the second biological feature of the object, to identify the identity information of the first object. In other words, the identity identification condition in the 1vN identity identification link is relaxed, so that an object that is suspected to be the first object is first identified, then a biological feature of the object under another posture or in another environment is determined, and the current biological feature of the first object is compared with the biological feature of the object under the another posture or in the another environment, to identify the identity information of the first object. A principle followed by this practice is as follows: A biological feature of an object slightly changes because an environment, a posture, and the like of the object change. Consequently, identity information of the object cannot be identified in the current 1vN identity identification manner. However, even if the posture and the environment of the object change, a biological feature image shot in this case is still a biological feature image of the same object. Therefore, there is substantial consistency between a current biological feature of the object and a stored biological feature of the object, and the consistency ensures successful implementation of the present disclosure.

For example, it is assumed that the backend server stores a palm print feature of an object 1 without shielding and a palm print feature of the object 1 when a partial palm is shielded. When the backend server obtains a current palm print feature of the object 1, the backend server first performs identity identification on the object 1 in the 1vN identity identification manner, which includes comparing, by the backend server, the current palm print feature of the object 1 with the palm print feature of the object without shielding, to perform identity identification on the object 1. If the identity identification on the object 1 fails, and assuming that the backend server detects the object 1 by relaxing the identity identification condition in the 1vN identity identification link, the backend server may compare the current palm print feature of the object 1 with the stored palm print feature when the partial palm is shielded, to perform identity identification on the object 1.

For example, it is assumed that the backend server stores a face feature of an object 1 when a mask is not worn and a face feature when the mask is worn. When the backend server obtains a current face feature of the object 1, the backend server first performs identity identification on the object 1 in the 1vN identity identification manner, which includes comparing, by the backend server, the current face feature of the object 1 and the face feature of the object 1 when the mask is not worn, to perform identity identification on the object 1. If the identity identification on the object 1 fails, and assuming that the backend server detects the object 1 by relaxing the identity identification condition in the 1vN identity identification link, the backend server may compare the current face feature of the object 1 with the stored face feature when the mask is worn, to perform identity identification on the object 1.

In some possible implementations, if there is no second object in the N objects, the backend server identifies the identity information of the first object based on a terminal identifier of the first object.

In some possible implementations, if the second object does not have the second biological feature, the backend server identifies the identity information of the first object based on a terminal identifier of the first object.

In some possible implementations, the terminal identifier of the first object may be a mobile phone number of the first object, for example, last four digits of the mobile phone number, but is not limited thereto.

In some possible implementations, the identifying the identity information of the first object based on a terminal identifier of the first object includes: The backend server detects, based on the terminal identifier of the first object, a status of enabling a biological feature recognition-related function of the first object. If the first object has enabled the biological feature recognition-related function, the backend server identifies the identity information of the first object based on the current biological feature of the first object and a first biological feature of the first object.

In some possible implementations, the status of enabling the biological feature recognition-related function of the first object includes two cases in which the first object has enabled the biological feature recognition-related function and the first object does not enable the biological feature recognition-related function.

In some possible implementations, a manner in which the backend server identifies the identity information of the first object based on the current biological feature of the first object and the first biological feature of the first object is the current 1v1 identity identification manner.

In some possible implementations, that the backend server identifies the identity information of the first object based on the similarity between the current biological feature of the first object and the first biological feature of the first object includes: If the similarity between the current biological feature of the first object and the first biological feature of the first object is greater than a fourth similarity threshold, the backend server determines identity information that is of the object and that corresponds to the first biological feature as the identity information of the first object.

In some possible implementations, that the backend server identifies the identity information of the first object based on the similarity between the current biological feature of the first object and the first biological feature of the first object includes: If the similarity between the current biological feature of the first object and the first biological feature of the first object is greater than or equal to the fourth similarity threshold, the backend server determines identity information that is of the object and that corresponds to the first biological feature as the identity information of the first object.

In some possible implementations, the fourth similarity threshold is less than the first similarity threshold, but is not limited thereto.

In some possible implementations, that the backend server identifies the identity information of the first object based on the similarity between the current biological feature of the first object and the first biological feature of the first object includes: If a similarity score between the current biological feature of the first object and the first biological feature of the first object is greater than a fourth score threshold, the backend server determines identity information that is of the object and that corresponds to the first biological feature as the identity information of the first object.

In some possible implementations, that the backend server identifies the identity information of the first object based on the similarity between the current biological feature of the first object and the first biological feature of the first object includes: If the similarity score between the current biological feature of the first object and the first biological feature of the first object is greater than or equal to the fourth score threshold, the backend server determines identity information that is of the object and that corresponds to the first biological feature as the identity information of the first object.

In some possible implementations, the fourth score threshold is less than the first score threshold, but is not limited thereto.

In some possible implementations, if the first object has enabled the biological feature recognition-related function, and the backend server successfully identifies the identity information of the first object based on the current biological feature of the first object and the first biological feature of the first object, the backend server uses the current biological feature of the first object as a second biological feature of the first object, and stores the second biological feature of the first object. In other words, the backend server may use the current biological feature of the first object as a secondary biological feature of the first object, and stores the biological feature, to subsequently perform identity identification on the object or another object.

In some possible implementations, provided that the first object has enabled the biological feature recognition-related function, and the backend server successfully identifies the identity information of the first object based on the current biological feature of the first object and the first biological feature of the first object, the backend server uses the current biological feature of the first object as the second biological feature of the first object, and stores the second biological feature of the first object.

In some other possible implementations, before using the current biological feature of the first object as the second biological feature of the first object and storing the second biological feature of the first object, the backend server may determine a quality score of a current biological feature collection image corresponding to the current biological feature of the first object. Correspondingly, if the quality score of the current biological feature collection image is greater than a preset score, the backend server uses the current biological feature of the first object as the second biological feature of the first object, and stores the second biological feature of the first object.

In this implementation, the backend server can store a biological feature with relatively high quality, to improve accuracy of identity identification.

In some possible implementations, the backend server may input the current biological feature collection image into a neural network model, to obtain the quality score of the current biological feature collection image.

As described above, the neural network model may be referred to as a sixth neural network model.

In some possible implementations, the backend server may obtain a training sample of the sixth neural network model; and trains the sixth neural network model by using the training sample of the sixth neural network model.

In some possible implementations, each training sample of the sixth neural network model may include: a to-be-scored biological feature collection image and an actual quality score of the biological feature collection image. The actual quality score may be used as a sample label. A training device may use a supervised training manner. For example, the training device may input the to-be-scored biological feature collection image into the sixth neural network model, and output a predicted quality score corresponding to the to-be-scored biological feature collection image. Further, the training device may calculate a loss based on predicted quality scores and actual quality scores that are included in all the training samples, adjust a parameter of the sixth neural network model based on the loss, and stop training when a quantity of times of training reaches a preset quantity or the loss reaches a minimum value.

In some possible implementations, when the training device trains the sixth neural network model, a loss function used by the training device may be any one of the following, but is not limited to: an L1 loss function, a mean squared error (MSE) loss function, a cross entropy loss function, and the like.

For example, FIG. 3 is a schematic diagram of a sixth neural network model according to an embodiment of the present disclosure. As shown in FIG. 3, the sixth neural network model may include: a convolutional layer, a residual layer, and a fully connected layer.

For example, the loss function of the sixth neural network model may be as follows:

$$L ( Y \vert f ( X ) ) = {\sum }_{M - 1} {( Y - f ( X ) )}^{2} .$$

X represents a biological feature image, f(·) represents a target function, Y represents an actual quality score corresponding to the biological feature image, and is used as a sample label, and M−1 represents a quantity of samples.

In some possible implementations, a sample label of each training sample may be labeled manually or may be labeled automatically. The following describes the automatic labeling manner.

In some possible implementations, the training device may obtain M biological feature images of a third object, M being an integer greater than 1; select a target biological feature image with highest quality in the M biological feature images; calculate similarities between the target biological feature image and other M−1 biological feature images than the target biological feature image in the M biological feature images; and form M−1 training samples of the neural network model by using the other M−1 biological feature images and a similarity between the target biological feature image and each of the other M−1 biological feature images. In other words, each training sample of the neural network model includes: a biological feature image and a similarity between the image and a target biological feature image. The similarity may be used as an actual quality score of the biological feature image.

In some possible implementations, the backend server may select the target biological feature image with highest quality in the M biological feature images through a quality recognition module or quality recognition software, but is not limited thereto.

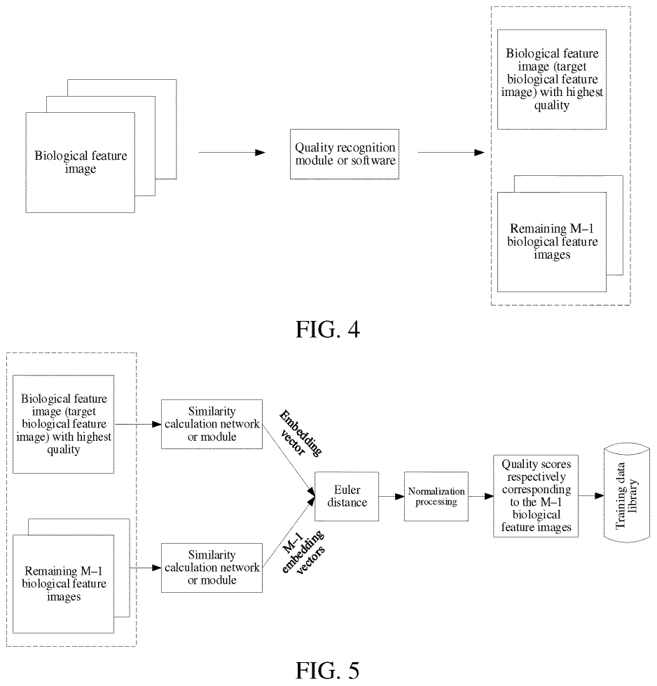

For example, FIG. 4 is a schematic diagram of selecting a biological feature image according to an embodiment of the present disclosure. As shown in FIG. 4, a plurality of biological feature images of at least one object may be stored in a biological feature image library. The backend server may recognize a biological feature image with highest quality and remaining biological feature images of each object through a quality recognition module or quality recognition software. In FIG. 4, an example in which an object includes M biological feature images is used. The backend server may recognize a biological feature image with highest quality and remaining M−1 biological feature images of the object through the quality recognition module or the software.

In some possible implementations, the backend server may calculate similarities between the target biological feature image and other M−1 biological feature images than the target biological feature image in the M biological feature images through a similarity calculation network or module, and form M−1 training samples of the neural network model by using the other M−1 biological feature images and a similarity between the target biological feature image and each of the other M−1 biological feature images.

For example, FIG. 5 is a schematic diagram of generating a training sample according to an embodiment of the present disclosure. As shown in FIG. 5, the backend server may convert a target biological feature image of an object into an embedding vector through a similarity calculation network or module, convert remaining M−1 biological feature images of the object into M−1 embedding vectors, further may calculate an Euler distance between the embedding vector corresponding to the target biological feature image and each of the M−1 embedding vectors, perform normalization processing on M−1 Euler distances, to obtain quality scores respectively corresponding to the M−1 biological feature images, that is, similarities between the other M−1 biological feature images and the target biological feature image, finally form M−1 training samples of a neural network model by using the other M−1 biological feature images and the similarities between the other M−1 biological feature images and the target biological feature image, and store the training samples into a training data library.

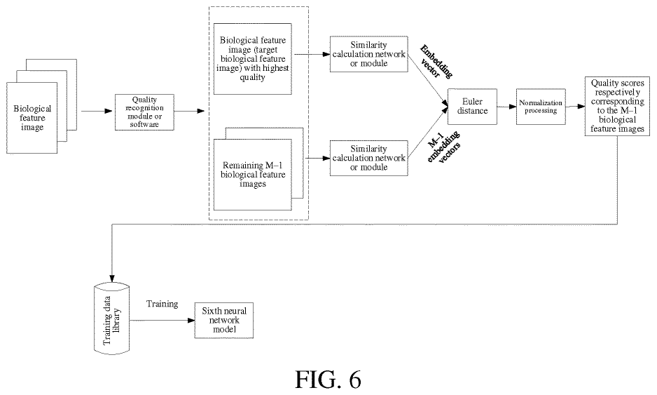

For example, FIG. 6 is a schematic diagram of preprocessing and model training according to an embodiment of the present disclosure. As shown in FIG. 6, a preprocessing process includes: A plurality of biological feature images of at least one object may be stored in a biological feature image library, and the backend server may recognize a biological feature image with highest quality of an object and remaining M−1 biological feature images of the object through a quality recognition module or quality recognition software. The backend server may convert a target biological feature image of an object into an embedding vector through a similarity calculation network or module, convert remaining M−1 biological feature images of the object into M−1 embedding vectors, further may calculate an Euler distance between the embedding vector corresponding to the target biological feature image and each of the M−1 embedding vectors, perform normalization processing on M−1 Euler distances, to obtain similarities between the other M−1 biological feature images and the target biological feature image, finally form M−1 training samples of a neural network model by using the other M−1 biological feature images and the similarities between the other M−1 biological feature images and the target biological feature image, and store the training samples into a training data library. A model training process includes: The backend server may train the sixth neural network model by using the training samples in the training data library.

In this embodiment of the present disclosure, similarities between M−1 biological feature images of the same object and a biological feature image with highest quality of the object under different postures or in different environments may be calculated. For any one of the M−1 biological feature images, a larger similarity corresponding to the biological feature image indicates higher quality of the biological feature image, and a smaller similarity corresponding to the biological feature image indicates lower quality of the biological feature image. A function of the sixth neural network model is to select biological feature images of the same object under different postures or in different environments. Therefore, a function of the foregoing automatically labeled training sample is consistent with that of the sixth neural network model. These training samples may be configured for training the sixth neural network model, so that the sixth neural network model may be configured to select biological feature images of the same object under different postures or in different environments, so that these biological feature images may be applied to a subsequent identity identification process.

A storage manner of the second biological features of the N objects and a storage manner of the second biological feature of the first object are the same, that is, after identity information of an object is successfully identified in the current 1v1 identity identification manner, a current biological feature of the object is used as a second biological feature, and the second biological feature is stored.

In some possible implementations, if the first object does not enable the biological feature recognition-related function, the backend server may trigger the first object to enable the biological feature recognition-related function.

In some possible implementations, if the first object does not enable the biological feature recognition-related function, the backend server may use the current biological feature of the first object as a first biological feature of the first object, and store the first biological feature of the first object. In other words, the first object is a new object. The backend server may use a first biological feature of the first object as a main biological feature of the first object and store the first biological feature.

In some possible implementations, in this embodiment of the present disclosure, a quantity of second biological features of each object may be limited, to reduce complexity of an identity identification system.

For example, the backend server may store at most five second biological features of one object, and the backend server may select to delete some second biological features when a quantity of second biological features exceeds the quantity of second biological features.

In some possible implementations, if the identification on the identity information of the first object based on the current biological feature of the first object and the respective second biological features of the N objects fails, the identity information of the first object is identified based on the terminal identifier of the first object.

In other words, if the identification on the identity information of the first object in the identity identification verification manner provided in this embodiment of the present disclosure fails, the backend server identifies the identity information of the first object based on the terminal identifier of the first object. For how to identify the identity information of the first object based on the terminal identifier of the first object, reference may be made to the foregoing descriptions. Details are not described in this embodiment of the present disclosure again.

The identity identification method provided in this embodiment of the present disclosure includes: obtaining a current biological feature of a first object; identifying identity information of the first object based on the current biological feature of the first object and respective first biological features of N objects, N being a positive integer; and identifying the identity information of the first object based on the current biological feature of the first object and respective second biological features of the N objects if the identification on the identity information of the first object based on the current biological feature of the first object and the respective first biological features of the N objects fails. Because when identity identification on the first object in a 1vN identity identification manner fails, a current 1v1 mobile phone number verification link is not directly entered, but a link in which identity identification verification is performed by using a second biological feature is added. The current 1v1 mobile phone number verification stage is entered only when the verification fails in this link. When identification succeeds by using the second biological feature, the 1v1 mobile phone number verification stage does not need to be entered. The identity identification verification link provided in this embodiment of the present disclosure is an automatic link and has shorter identification time than the 1v1 mobile phone number verification stage. Therefore, the identity identification time can be shortened in the identity identification manner provided in this embodiment of the present disclosure, and the object may not need to perform UI interaction, to finally improve object experience.

For any object, a first biological feature and a second biological feature that are of the object may be biological features extracted based on biological feature images of the object collected under different postures or in different environments. Therefore, actual meaning of the identity identification method provided in this embodiment of the present disclosure is that the backend server may store biological features of the same object under different postures or in different environments. During identity identification, the backend server may compare a current biological feature of the same object with the biological features under different postures or in different environments, to identify identity information of the object. This manner can improve a hit rate of identity identification.

The following exemplarily describes the identity identification method provided in this embodiment of the present disclosure by using an example.

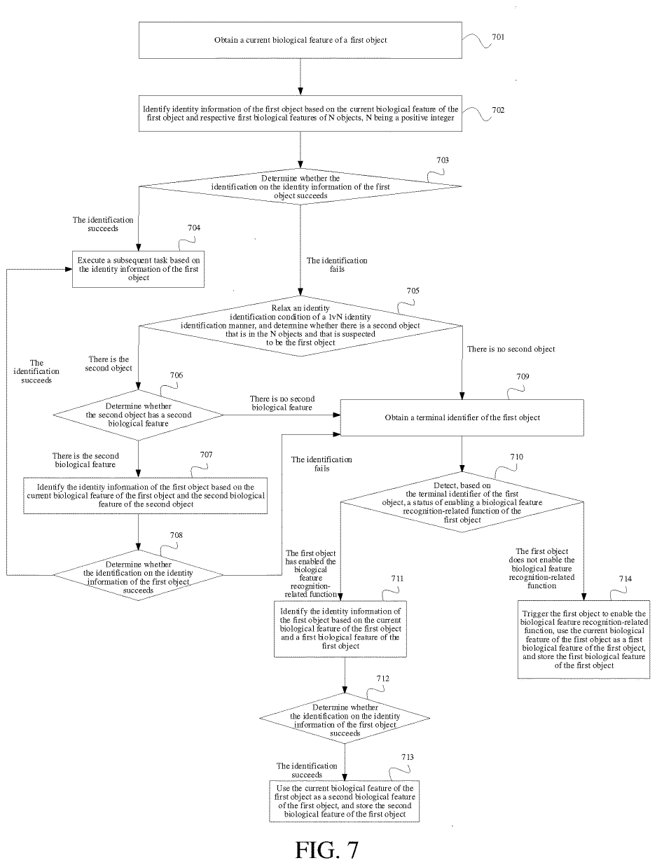

For example, FIG. 7 is a flowchart of another identity identification method according to an embodiment of the present disclosure. As shown in FIG. 7, the method may be performed by a backend server corresponding to an application configured to implement a biological feature recognition-related function. For example, the backend server may be a backend server corresponding to a payment backend server, a membership point mini program, or a mobile power pack leasing mini program, but is not limited thereto. As shown in FIG. 7, the method may include the following operations.

S701: Obtain a current biological feature of a first object.

For explanations and descriptions of S701, reference may be made to the explanations and descriptions of S210. Details are not described in this embodiment of the present disclosure again.

S702: Identify identity information of the first object based on the current biological feature of the first object and respective first biological features of N objects, N being a positive integer.

For explanations and descriptions of S702, reference may be made to the explanations and descriptions of S220. Details are not described in this embodiment of the present disclosure again.

S703: Determine whether the identification on the identity information of the first object succeeds. If the identification succeeds, S704 is performed. If the identification fails, S705 is performed.

S704: Execute a subsequent task based on the identity information of the first object.

In some possible implementations, the subsequent task may be a payment task, a membership point task, a task of leasing a mobile power pack without a rent, or the like, but is not limited thereto.

S705: Relax an identity identification condition of a 1vN identity identification manner, and determine whether there is a second object that is in the N objects and that is suspected to be the first object. If there is the second object, S706 is performed. If there is no second object, S709 is performed.

In some possible implementations, for a manner of relaxing the identity identification condition and a manner of determining the second object, reference may be made to the explanations and descriptions of S230. Details are not described in this embodiment of the present disclosure again.

S706: Determine whether the second object has a second biological feature. If there is the second biological feature, S707 is performed. If there is no second biological feature, S709 is performed.

For explanations and descriptions of the second biological feature, reference may be made to the explanations and descriptions of S203. Details are not described in this embodiment of the present disclosure again.

S707: Identify the identity information of the first object based on the current biological feature of the first object and the second biological feature of the second object.

For explanations and descriptions of S770, reference may be made to the explanations and descriptions of S230. Details are not described in this embodiment of the present disclosure again.

S708: Determine whether the identification on the identity information of the first object succeeds. If the identification succeeds, S704 is performed. If the identification fails, S709 is performed.

S709: Obtain a terminal identifier of the first object.

S710: Detect, based on the terminal identifier of the first object, a status of enabling a biological feature recognition-related function of the first object. If the first object has enabled the biological feature recognition-related function, S711 is performed. If the first object does not enable the biological feature recognition-related function, S714 is performed.

The terminal identifier of the first object has a correspondence with the status of enabling the biological feature recognition-related function of the first object.

S711: Identify the identity information of the first object based on the current biological feature of the first object and a first biological feature of the first object.

An identity identification manner in S711 is a current 1v1 identity identification manner. For explanations and descriptions of the manner, reference may be made to the foregoing descriptions. Details are not described in this embodiment of the present disclosure again.

S712: Determine whether the identification on the identity information of the first object succeeds. If the identification succeeds, S713 is performed.

In some possible implementations, if the identification on the identity information of the first object in the 1v1 identity identification manner fails, the backend server may trigger the terminal device to recollect a biological feature image of the first object, but is not limited thereto.

S713: Use the current biological feature of the first object as a second biological feature of the first object, and store the second biological feature of the first object.

For explanations and descriptions of S713, reference may be made to the explanations and descriptions of S230. Details are not described in this embodiment of the present disclosure again.

S714: Trigger the first object to enable the biological feature recognition-related function, use the current biological feature of the first object as a first biological feature of the first object, and store the first biological feature of the first object.

For explanations and descriptions of S714, reference may be made to the explanations and descriptions of S230. Details are not described in this embodiment of the present disclosure again.

According to the identity identification method provided in this embodiment of the present disclosure, after identification on an identity of an object in a 1vN manner fails, a 1v1 mobile phone number verification stage is not directly entered, but a link in which identity identification verification is performed by using a second biological feature is added. The 1v1 mobile phone number verification stage is entered only when the verification fails in this link. When identification by using the second biological feature succeeds, the 1v1 mobile phone number verification stage does not need to be entered, so that identity identification time can be shortened, and the object may not need to perform UI interaction, to finally improve object experience. In addition, problems of high training costs and incomplete coverage caused by an identity identification manner implemented through augmentation of training data can be avoided.

The preferred implementations of the present disclosure are described in detail above with reference to the accompanying drawings. However, the present disclosure is not limited to the specific details in the foregoing implementations. In the scope of the technical idea of the present disclosure, various simple variants can be made on the technical solution of the present disclosure, and the simple variants all belong to the protection scope of the present disclosure. For example, the specific technical features described in the above specific implementations may be combined in any suitable manner without contradiction. To avoid unnecessary repetition, various possible combinations are not further described in the present disclosure. For another example, the various implementations of the present disclosure may be combined without departing from the idea of the present disclosure, and such combinations shall also fall within the scope of the present disclosure.

In various method embodiments of the present disclosure, an order of sequence numbers of the foregoing processes does not indicate an execution sequence, and execution sequences of the processes are to be determined according to functions and internal logics thereof and are not to impose any limitation on an implementation process of the embodiments of the present disclosure.

The method provided in this embodiment of the present disclosure is described above, and an identity identification apparatus provided in an embodiment of the present disclosure is described below.

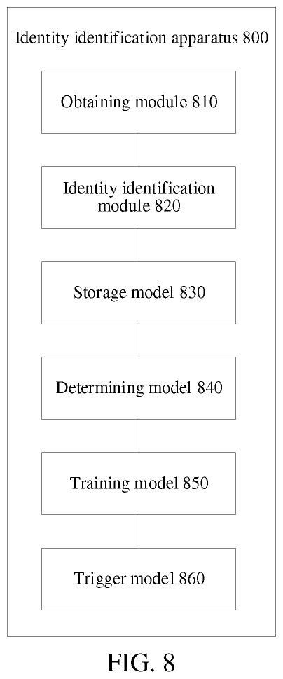

FIG. 8 is a schematic diagram of an identity identification apparatus 800 according to an embodiment of the present disclosure. As shown in FIG. 8, the apparatus 800 includes: an obtaining module 810 and an identity identification module 820. The obtaining module 810 is configured to obtain a current biological feature of a first object. The identity identification module 820 is configured to: identify identity information of the first object based on the current biological feature and respective first biological features of N objects, N being a positive integer; and identify the identity information of the first object based on the current biological feature of the first object and respective second biological features of the N objects if the identification on the identity information of the first object based on the current biological feature of the first object and the respective first biological features of the N objects fails.

In some possible implementations, the identity identification module 820 is specifically configured to identify the identity information of the first object based on the current biological feature of the first object and a second biological feature of each of the N objects.

In some possible implementations, the identity identification module 820 is specifically configured to: detect a second object that is in the N objects and that is suspected to be the first object; and if there is the second object in the N objects and the second object has a second biological feature, identify the identity information of the first object based on the current biological feature of the first object and the second biological feature of the second object.

In some possible implementations, the identity identification module 820 is specifically configured to: reduce a first similarity threshold used when the identity information of the first object is identified based on the current biological feature of the first object and the respective first biological features of the N objects, to obtain a second similarity threshold; calculate similarities between the current biological feature of the first object and the respective first biological features of the N objects; and determine an object that is in the N objects and whose similarity is greater than the second similarity threshold as the second object.

In some possible implementations, the identity identification module 820 is specifically configured to: if the second object has a plurality of second biological features, calculate a similarity between the current biological feature of the first object and each second biological feature of the second object; and identifies the identity information of the first object based on the similarity between the current biological feature of the first object and each second biological feature of the second object.

In some possible implementations, the identity identification module 820 is specifically configured to: if the second object has a plurality of second biological features, sequentially calculate similarities between the current biological feature of the first object and the plurality of second biological features of the second object in descending order of quality of biological feature collection images respectively corresponding to the plurality of second biological features; and if a similarity between the current biological feature of the first object and a target second biological feature of the second object is greater than a third similarity threshold, use identity information of the second object as the identity information of the first object, and stop calculating a similarity between the current biological feature of the first object and another second biological feature of the second object.

In some possible implementations, the identity identification module 820 is further configured to: if there is no second object in the N objects, identify the identity information of the first object based on a terminal identifier of the first object.

In some possible implementations, the identity identification module 820 is further configured to: if the second object does not have the second biological feature, identify the identity information of the first object based on a terminal identifier of the first object.

In some possible implementations, the identity identification module 820 is specifically configured to: detect, based on the terminal identifier of the first object, a status of enabling a biological feature recognition-related function of the first object; and if the first object has enabled the biological feature recognition-related function, identify the identity information of the first object based on the current biological feature of the first object and a first biological feature of the first object.

In some possible implementations, the apparatus 800 further includes a storage model 830, configured to: if the identification on the identity information of the first object based on the current biological feature of the first object and the first biological feature of the first object succeeds, use the current biological feature of the first object as a second biological feature of the first object, and store the second biological feature of the first object.

In some possible implementations, the apparatus 800 further includes a determining model 840, configured to: before the storage model 830 uses the current biological feature of the first object as the second biological feature of the first object and stores the second biological feature of the first object, determine a quality score of a current biological feature collection image corresponding to the current biological feature of the first object. Correspondingly, the storage model 830 is specifically configured to: if the quality score of the current biological feature collection image is greater than a preset score, use the current biological feature of the first object as the second biological feature of the first object, and store the second biological feature of the first object.

In some possible implementations, the determining model 840 is specifically configured to: input the current biological feature collection image into a neural network model, to obtain the quality score of the current biological feature collection image.

In some possible implementations, the apparatus 800 further includes a training model 850. The obtaining module 810 is further configured to obtain a training sample of the neural network model. The training model 850 is configured to train the neural network model by using the training sample of the neural network model.

In some possible implementations, the obtaining module 810 is specifically configured to: obtain M biological feature images of a third object, M being an integer greater than 1; select a target biological feature image with highest quality in the M biological feature images; calculate similarities between the target biological feature image and other M−1 biological feature images than the target biological feature image in the M biological feature images; and form M−1 training samples of the neural network model by using the other M−1 biological feature images and a similarity between the target biological feature image and each of the other M−1 biological feature images.

In some possible implementations, the apparatus 800 further includes a trigger model 860. If the first object does not enable the biological feature recognition-related function, the trigger model 860 is configured to trigger the first object to enable the biological feature recognition-related function.

In some possible implementations, if the first object does not enable the biological feature recognition-related function, the storage model 830 is further configured to use the current biological feature of the first object as the first biological feature of the first object, and store the first biological feature of the first object.

In some possible implementations, the obtaining module 810 is specifically configured to: obtain a current biological feature collection image of the first object; and perform feature extraction on the current biological feature collection image, to obtain the current biological feature of the first object.

The apparatus embodiment and the method embodiment may correspond to each other. For similar descriptions, refer to the method embodiment. To avoid repetition, details are not described herein again. Specifically, the apparatus 800 shown in FIG. 8 may execute the method embodiments corresponding to FIG. 2 and FIG. 7, and the foregoing and other operations and/or functions of the modules in the apparatus 800 are separately configured for implementing corresponding procedures in the methods in FIG. 2 and FIG. 7. For brevity, details are not described herein again.

The apparatus 800 in this embodiment of the present disclosure is described above from the perspective of the functional modules with reference to the accompanying drawings. The functional module may be implemented in a hardware form, may be implemented in an instruction in a software form, or may be implemented in a combination of hardware and software modules. Specifically, the operations of the method embodiments in the embodiments of the present disclosure may be completed by using an integrated logic circuit of hardware in a processor and/or instructions in a form of software. Operations of the methods disclosed with reference to the embodiments of the present disclosure may be directly performed and completed by using a hardware decoding processor, or may be performed and completed by using a combination of hardware and a software module in the decoding processor. In some embodiments, the software module may be located in a mature storage medium in the field, such as a random access memory, a flash memory, a read-only memory, a programmable read-only memory, an electrically-erasable programmable memory, or a register. The storage medium is located in the memory, and the processor reads information in the memory and completes the operations in the foregoing method embodiments in combination with hardware thereof.

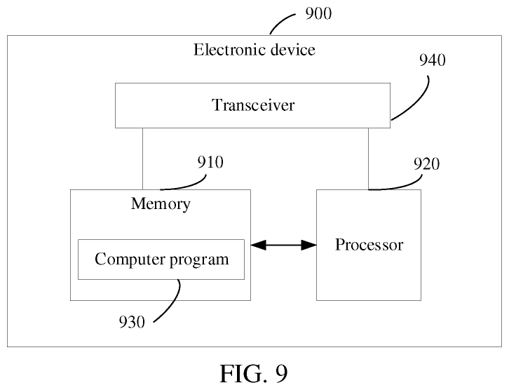

FIG. 9 is a schematic block diagram of an electronic device 900 according to an embodiment of the present disclosure. The electronic device 900 may be the foregoing backend server, but is not limited thereto. As shown in FIG. 9, the electronic device 900 may include:
a memory 910 and a processor 920, the memory 910 being configured to store a computer program 930 and transmit the computer program 930 to the processor 920. In other words, the processor 920 may invoke the computer program 930 from the memory 910 and run the computer program 930, to implement the method in the embodiments of the present disclosure.

For example, the processor 920 may be configured to perform the operations in the method according to instructions in the computer program 930.

In some embodiments of the present disclosure, the processor 920 may include but is not limited to:
a general purpose processor, a digital signal processor (DSP), an application specific integrated circuit (ASIC), a field programmable gate array (FPGA) or another programmable logical device, a discrete gate or transistor logic device, a discrete hardware component, or the like.

In some embodiments of the present disclosure, the memory 910 includes but is not limited to:
a volatile and/or a non-volatile memory. The non-volatile memory may be a read-only memory (ROM), a programmable ROM (PROM), an erasable programmable read-only memory (EPROM), an electrically EPROM (EEPROM), or a flash memory. The volatile memory may be a random access memory (RAM), and is used as an external cache. It is described as an example but not a limitation, many forms of RAMs, for example, a static random access memory (SRAM), a dynamic random access memory (DRAM), a synchronous dynamic random access memory (SDRAM), a double data rate synchronous dynamic random access memory (DDR SDRAM), an enhanced synchronous dynamic random access memory (ESDRAM), a synchlink dynamic random access memory SLDRAM), and a direct rambus random access memory (DR RAM), may be used.

In some embodiments of the present disclosure, the computer program 930 may be divided into one or more modules. The one or more modules are stored in the memory 910, and are executed by the processor 920, to complete the method provided in the present disclosure. The one or more modules may be a series of computer program instruction segments that can perform a specific function, and the instruction segment is configured to describe an execution process of the computer program 930 in the electronic device.

As shown in FIG. 9, the electronic device 900 may further include:
a transceiver 940, where the transceiver 940 may be connected to the processor 920 or the memory 910.

The processor 920 may control the transceiver 940 to communicate with another device. Specifically, the transceiver may send information or data to the another device or receive information or data sent by the another device. The transceiver 940 may include a transmitter and a receiver. The transceiver 940 may further include an antenna, and there may be one or more antennas.

Components in the electronic device 900 are connected by a bus system. In addition to a data bus, the bus system further includes a power bus, a control bus, and a status signal bus.

An aspect of the present disclosure further provides a computer storage medium, having a computer program stored therein. When the computer program is executed by a computer, the computer is caused to perform the method according to the foregoing method embodiments. Alternatively, an embodiment of the present disclosure further provides a computer program product including instructions. When run on a computer, the instructions cause the computer to perform the method according to the method embodiments.

Another aspect of the present disclosure provides a computer program product or a computer program, the computer program product or the computer program including computer instructions, the computer instructions being stored in a computer-readable storage medium. A processor of a computer device reads the computer instructions from the computer-readable storage medium, and the processor executes the computer instructions, to cause the computer device to perform the methods in the method embodiments.

In other words, when software is configured for implementation, implementation may be entirely or partially performed in the form of a computer program product. The computer program product includes one or more computer instructions. When the computer program instructions are loaded and executed on the computer, the procedures or functions according to the embodiments of the present disclosure are all or partially generated. The computer may be a general-purpose computer, a dedicated computer, a computer network, or other programmable apparatuses. The computer instructions may be stored in a computer-readable storage medium or may be transmitted from a computer-readable storage medium to another computer-readable storage medium. For example, the computer instructions may be transmitted from a website, computer, server, or data center to another website, computer, server, or data center in a wired (for example, a coaxial cable, an optical fiber, or a digital subscriber line (digital subscriber line, DSL)) or wireless (for example, infrared, radio, or microwave) manner. The computer-readable storage medium may be any available medium that a computer can access or a data storage device such as a server or a data center that includes one or more integrated available media. The available medium may be a magnetic medium (such as a floppy disk, a hard disk, or a magnetic tape), an optical medium (such as a digital video disc (DVD)), a semiconductor medium (such as a solid state disk (SSD)) or the like.

A person of ordinary skill in the art may be aware that, in combination with the examples described in the embodiments disclosed in this specification, modules and algorithm steps may be implemented by electronic hardware or a combination of computer software and electronic hardware. Whether the functions are performed by hardware or software depends on particular applications and design constraint conditions of the technical solutions. A person skilled in the art may use different methods to implement the described functions for each particular application, but it is not to be considered that the implementation goes beyond the scope of the present disclosure.

In the several embodiments provided in the present disclosure, the disclosed system, apparatus, and method may be implemented in other manners. For example, the described apparatus embodiment is merely exemplary. For example, the module division is merely logical function division and may be other division in actual implementation. For example, a plurality of modules or components may be combined or integrated into another system, or some features may be ignored or not performed. In addition, the displayed or discussed mutual couplings or direct couplings or communication connections may be implemented by using some interfaces. The indirect couplings or communication connections between the apparatuses or modules may be implemented in electronic, mechanical, or other forms.

The modules described as separate parts may or may not be physically separate, and parts displayed as modules may or may not be physical modules, may be located in one position, or may be distributed on a plurality of network units. Some or all of the modules may be selected according to actual needs to implement the solutions of the embodiments. In addition, functional modules in the embodiments of the present disclosure may be integrated into one processing module, or each of the modules may exist alone physically, or two or more modules may be integrated into one module.

The foregoing descriptions are merely specific implementations of the present disclosure, but are not intended to limit the protection scope of the present disclosure. Any variation or replacement readily figured out by a person skilled in the art within the technical scope disclosed in the present disclosure shall fall within the protection scope of the present disclosure. Therefore, the protection scope of the present disclosure shall be subject to the appended claims.

What is claimed is:

1. An identity identification method, comprising:
obtaining a current biological feature of a first object;
identifying identity information of the first object based on the current biological feature of the first object and first biological features of N objects, N being a positive integer; and
when identifying the identity information of the first object based on the current biological feature of the first object and the first biological features of the N objects fails, identifying the identity information of the first object based on the current biological feature of the first object and second biological features of the N objects.

2. The method according to claim 1, wherein identifying the identity information of the first object based on the current biological feature of the first object and the second biological features of the N objects comprises:
identifying the identity information of the first object based on the current biological feature of the first object and a second biological feature of each of the N objects among the second biological features of the N objects.

3. The method according to claim 1, wherein identifying the identity information of the first object based on the current biological feature of the first object and the second biological features of the N objects comprises:
detecting a second object, wherein the second object is in the N objects and is suspected to be the first object; and
when the second object has a second biological feature, identifying the identity information of the first object based on the current biological feature of the first object and the second biological feature of the second object.

4. The method according to claim 3, wherein detecting the second object comprises:
reducing a first similarity threshold used when the identity information of the first object is identified based on the current biological feature of the first object and the first biological features of the N objects, to obtain a second similarity threshold;
calculating similarities between the current biological feature of the first object and the first biological features of the N objects; and
determining a first selected object that is in the N objects as the second object, wherein a similarity between the current biological feature of the first object and a first biological feature of the first selected object is greater than the second similarity threshold.

5. The method according to claim 3, wherein detecting the second object comprises:
reducing a first score threshold used when the identity information of the first object is identified based on the current biological feature of the first object and the first biological features of the N objects, to obtain a second score threshold;
calculating similarities between the current biological feature of the first object and the first biological features of the N objects, and determining a similarity score corresponding to each similarity of the similarities; and
determining a second selected object that is in the N objects as the second object, wherein a similarity score between the current biological feature of the first object and a first biological feature of the second selected object is greater than the second score threshold.

6. The method according to claim 3, wherein the identifying the identity information of the first object based on the current biological feature and the second biological feature of the second object comprises:
if the second object has a plurality of second biological features, calculating a similarity between the current biological feature and each second biological feature of the second object; and
identifying the identity information of the first object based on the similarity between the current biological feature and each second biological feature of the second object.

7. The method according to claim 3, wherein identifying the identity information of the first object based on the current biological feature of the first object and the second biological feature of the second object comprises:
when the second object has a plurality of second biological features, sequentially calculating similarities between the current biological feature of the first object and the plurality of second biological features of the second object in descending order of quality of biological feature collection images corresponding to the plurality of second biological features; and
when a similarity between the current biological feature of the first object and a target second biological feature of the second object is greater than a third similarity threshold, using identity information of the second object as the identity information of the first object, and stopping calculating the similarities.

8. The method according to claim 3, further comprising:
when the second object is not in the N objects, identifying the identity information of the first object based on a terminal identifier of the first object.

9. The method according to claim 3, further comprising:
when the second object does not have the second biological feature, identifying the identity information of the first object based on a terminal identifier of the first object.

10. The method according to claim 1, wherein identifying the identity information of the first object based on a terminal identifier of the first object comprises:
detecting, based on the terminal identifier of the first object, a status of enabling a biological feature recognition-related function of the first object; and
when the first object has the biological feature recognition-related function of the first object, identifying the identity information of the first object based on the current biological feature of the first object and a first biological feature of the first object.

11. The method according to claim 10, further comprising:
when identifying the identity information of the first object based on the current biological feature of the first object and the first biological features of the N objects succeeds, using the current biological feature of the first object as a second biological feature of the first object, and storing the second biological feature of the first object.

12. The method according to claim 11, wherein before using the current biological feature of the first object as the second biological feature of the first object, and storing the second biological feature of the first object, the method further comprises:
determining a quality score of a current biological feature collection image corresponding to the current biological feature of the first object; and
wherein using the current biological feature of the first object as the second biological feature of the first object, and storing the second biological feature of the first object comprises:
when the quality score of the current biological feature collection image is greater than a preset score, using the current biological feature of the first object as the second biological feature of the first object, and storing the second biological feature of the first object.

13. The method according to claim 12, wherein determining the quality score of the current biological feature collection image corresponding to the current biological feature of the first object comprises:
inputting the current biological feature collection image into a neural network model, to obtain the quality score of the current biological feature collection image.

14. The method according to claim 13, further comprising:
obtaining a training sample of the neural network model; and
training the neural network model by using the training sample of the neural network model.

15. The method according to claim 14, wherein obtaining the training sample of the neural network model comprises:
obtaining M biological feature images of a third object, M being an integer greater than 1;
selecting a target biological feature image with a highest quality in the M biological feature images;
calculating similarities between the target biological feature image and other M−1 biological feature images than the target biological feature image in the M biological feature images; and
forming M−1 training samples of the neural network model by using the other M−1 biological feature images and a similarity between the target biological feature image and each of the other M−1 biological feature images.

16. The method according to claim 10, further comprising:
when the first object does not have the biological feature recognition-related function, triggering the first object to enable the biological feature recognition-related function.

17. The method according to claim 10, further comprising:
when the first object does not have the biological feature recognition-related function, using the current biological feature as the first biological feature of the first object, and storing the first biological feature of the first object.

18. The method according to claim 1, wherein obtaining the current biological feature of the first object comprises:
obtaining a current biological feature collection image of the first object; and
performing feature extraction on the current biological feature collection image, to obtain the current biological feature.

19. An identity identification apparatus, comprising a memory for storing instructions and a processor for executing the instructions to:
obtain a current biological feature of a first object;
identify identity information of the first object based on the current biological feature of the first object and first biological features of N objects, N being a positive integer; and
when identifying the identity information of the first object based on the current biological feature of the first object and the first biological features of the N objects fails, identify the identity information of the first object based on the current biological feature of the first object and second biological features of the N objects.

20. A non-transitory computer readable medium storing a plurality of instructions, wherein the plurality of instructions, when executed by a processor, configure the instructions to:
obtain a current biological feature of a first object;
identify identity information of the first object based on the current biological feature of the first object and first biological features of N objects, N being a positive integer; and
when identifying the identity information of the first object based on the current biological feature of the first object and the first biological features of the N objects fails, identify the identity information of the first object based on the current biological feature of the first object and second biological features of the N objects.
